(19) United States
(12) Patent Application Publication
(10) Pub. No.: US 2026/0179861 A1
(43) Pub. Date: Jun. 25, 2026

(54) MULTI-COLOR KEYBOARD KEYCAP WITH PROTRUDING CONTOUR LINE

(71) Applicant: Shenzhen Shicheng Optics Co., Ltd., Shenzhen (CN)

(72) Inventors: Chengxiao ZHONG, Shenzhen (CN); Jingyuan DENG, Shenzhen (CN)

(73) Assignee: Shenzhen Shicheng Optics Co., Ltd., Shenzhen, GD (CN)

(21) Appl. No.: 19/430,894

(22) Filed: Dec. 23, 2025

(30) Foreign Application Priority Data
Dec. 23, 2024 (CN) 2024231830807

(51) Int. Cl. H01H 13/04; H01H 13/02; H01H 13/86

(52) U.S. Cl. CPC H01H 13/04; H01H 13/023; H01H 13/86

(57) ABSTRACT

The present disclosure relates to a multi-color keyboard keycap with a protruding contour line, which includes a cap base and a cap cover connected to each other, the cap base and the cap cover are both cap-shaped with a bottom opening, the cap cover is installed on an outer side of the cap base, the cap base is a transparent or translucent cap-shaped body, an outer side of the cap base is provided with a contour ridge, the cap cover includes a top plate and a plurality of side plates, the plurality of side plates connect a side edge of the top plate through a connecting block to form a cap-shaped structure, and a contour line hole is formed between the top plate and the plurality of side plates; the contour ridge is matching installed in the contour line hole.

### CROSS-REFERENCE TO RELATED APPLICATION

This application claims priority to Chinese Patent Application No. 202423183080.7, filed on Dec. 23, 2024, which is hereby incorporated by reference in its entirety.

### TECHNICAL FIELD

The application relates to a field of keyboard keycap technology, and specifically relates to multi-color keyboard keycap with protruding contour line.

### BACKGROUND

Colors of existing keyboard keycaps are mostly an integral single color, which cannot meet a demand of enthusiasts in a market for keycap color matching. Some existing keyboards are equipped with a light at a key position to improve a visual effect, and a keycap is formed by injection molding of a transparent material or a translucent material to enable the keycap to transmit the light; however, although the transparent keycap can achieve a good light transmission effect, a color of the keycap itself cannot be highlighted; a keycap that can both achieve the light transmission effect and highlight an own color of the keycap urgently needs to be launched. To solve the above problems, the application provides a multi-color keyboard keycap with a protruding contour line.

### SUMMARY

In view of the above technical deficiencies, the present disclosure provides a multi-color keyboard keycap with a protruding contour line, wherein a complete keycap is formed by injection molding a cap base and a cap cover to realize a multi-color keyboard keycap; the cap base is a transparent or translucent cap-shaped body and the cap base is provided with a contour ridge; a light transmits through the contour ridge of the cap base to emit the light, and when matched with a color of the cap cover, both a light transmission effect and highlighting of an own color can be achieved; the technical problems raised in the background art are solved.

The present disclosure adopts the following technical solution: The present disclosure provides a multi-color keyboard keycap with a protruding contour line, including: a cap base and a cap cover connected to each other, wherein the cap base and the cap cover are both cap-shaped with a bottom opening, the cap cover is installed on an outer side of the cap base; by setting injection molding materials of different colors to successively injection mold the cap base and the cap cover, a multi-color keyboard keycap is realized and can be customized according to a requirement; the cap base is a transparent or translucent cap-shaped body, an outer side of the cap base is provided with a contour ridge; so that a light at a key position transmits through the contour ridge of the cap base to emit the light; meanwhile, the cap base itself can be injection molded with transparent or translucent materials of different colors, providing richer color effects; the cap cover incudes a top plate and a plurality of side plates, the plurality of side plates connect a side edge of the top plate through a connecting block to form a cap-shaped structure, a contour line hole is formed between the top plate and the plurality of side plates; the contour ridge is matching installed in the contour line hole.

In some embodiments, the contour ridge includes an upper ring ridge and a plurality of edge ridges integrally connected, a top plate groove is opened at a top end of the cap base, a side plate groove is opened on a side surface of the cap base, the protruding upper ring ridge is formed between the top plate groove and the plurality of side plate grooves, the protruding edge ridge is formed between two adjacent the side plate grooves; the edge ridge extends to a bottom end surface of the cap base, and a dimension of the upper ring ridge and a dimension of the edge ridge can be customized according to an actual requirement.

In some embodiments, the top plate is matching installed in the top plate groove; the side plate is matching installed in the side plate groove; when the top plate and the plurality of side plates of the cap cover are installed in the corresponding top plate groove and the side plate groove, an upper end surface of the upper ring ridge connects smoothly with an upper surface of the top plate, a side surface of the upper ring ridge and two outer side surfaces of the edge ridge connect smoothly with an outer side surface of a corresponding the side plate, ensuring that an outer surface of the entire keycap is smooth without affecting a user experience.

In some embodiments, a plurality of connecting holes are opened along a bottom surface edge line of the top plate groove of the cap base, the connecting hole extends and penetrates through a bottom surface of the side plate groove, the connecting block is matching installed in the connecting hole; by installing the connecting block in the connecting hole, the connecting block is integrally injection molded with the top plate and the plurality of side plates of the cap cover and connected to the cap base, ensuring a stability of a connection between the cap base and the cap cover.

In some embodiments, a plurality of strip-shaped reinforcing holes are opened on a bottom surface of the top plate groove; a plurality of strip-shaped reinforcing ribs are integrally connected to an inner bottom surface of the cap cover, the strip-shaped reinforcing rib is correspondingly matching installed in the strip-shaped reinforcing hole; by installing the strip-shaped reinforcing rib in the strip-shaped reinforcing hole, the strip-shaped reinforcing rib is integrally injection molded with the top plate and the plurality of side plates of the cap cover and connected to the cap base, ensuring a stability of a connection between the cap base and the cap cover.

In some embodiments, a plurality of connecting posts are integrally connected to an inner bottom of the cap base, a cross-shaped connecting hole is opened at a bottom end of the connecting post, the cross-shaped connecting hole is matching installed with a cross-shaped fixture of a corresponding key position of a keyboard; facilitating an installation of the keycap on the corresponding key position of the keyboard.

A beneficial effect of the present disclosure is:

The present disclosure forms a complete keycap by injection molding the cap base and the cap cover to realize a multi-color keyboard keycap; the cap base is a transparent or translucent cap-shaped body and the cap base is provided with a contour ridge; a light transmits through the contour ridge of the cap base to emit the light, and when matched with a color of the cap cover, both a light transmission effect and highlighting of an own color can be achieved; meanwhile, the cap base itself can be injection molded with transparent or translucent materials of different colors, providing richer color effects and meeting a market demand.

### BRIEF DESCRIPTION OF THE DRAWINGS

In order to more clearly illustrate technical solutions in embodiments of the application, drawings required for describing the embodiments will be briefly introduced below. Obviously, the drawings described below are only some embodiments of the application. For a person of ordinary skill in the art, other drawings can also be obtained based on these drawings without creative labor.

FIG. 1 is a structural schematic diagram of a spacebar keycap of a multi-color keyboard keycap with a protruding contour line provided by the application.

FIG. 2 is a structural schematic diagram of FIG. 1 from a bottom view angle.

FIG. 3 is a structural schematic diagram of a cap base in FIG. 1.

FIG. 4 is a structural schematic diagram of a cap cover in FIG. 1 from a top view angle.

FIG. 5 is a structural schematic diagram of the cap cover in FIG. 1 from a bottom view angle.

FIG. 6 is a structural schematic diagram of an Enter key keycap of a multi-color keyboard keycap with a protruding contour line provided by the application.

FIG. 7 is a structural schematic diagram of a cap base in FIG. 6.

FIG. 8 is a structural schematic diagram of a cap cover in FIG. 6.

FIG. 9 is a structural schematic diagram of a multi-color keyboard with a protruding contour line provided by embodiment 2 of the application.

FIG. 10 is a structural schematic diagram of a multi-color keyboard with a protruding contour line provided by embodiment 3 of the application.

FIG. 11 is a structural schematic diagram of a multi-color keyboard with a protruding contour line provided by embodiment 4 of the application from a top view angle.

FIG. 12 is a structural schematic diagram of a multi-color keyboard keycap with a protruding contour line provided by embodiment 5 of the application from a front view.

FIG. 13 is a structural schematic diagram of FIG. 12 from a rear view angle.

FIG. 14 is a structural schematic diagram of FIG. 12 from a left view angle.

FIG. 15 is a structural schematic diagram of FIG. 12 from a right view angle.

FIG. 16 is a structural schematic diagram of FIG. 12 from a top view angle.

FIG. 17 is a structural schematic diagram of FIG. 12 from a bottom view angle.

FIG. 18 is a three-dimensional diagram of FIG. 12.

FIG. 19 is a structural schematic diagram of a multi-color keyboard keycap with a protruding contour line provided by embodiment 6 of the application from a front view.

FIG. 20 is a structural schematic diagram of FIG. 19 from a rear view angle.

FIG. 21 is a structural schematic diagram of FIG. 19 from a left view angle.

FIG. 22 is a structural schematic diagram of FIG. 19 from a right view angle.

FIG. 23 is a structural schematic diagram of FIG. 19 from a top view angle.

FIG. 24 is a structural schematic diagram of FIG. 19 from a bottom view angle.

FIG. 25 is a three-dimensional diagram of FIG. 19.

FIG. 26 is a structural schematic diagram of a multi-color keyboard keycap with a protruding contour line provided by embodiment 7 of the application from a front view.

FIG. 27 is a structural schematic diagram of FIG. 26 from a rear view angle.

FIG. 28 is a structural schematic diagram of FIG. 26 from a left view angle.

FIG. 29 is a structural schematic diagram of FIG. 26 from a right view angle.

FIG. 30 is a structural schematic diagram of FIG. 26 from a top view angle.

FIG. 31 is a structural schematic diagram of FIG. 26 from a bottom view angle.

FIG. 32 is a three-dimensional diagram of FIG. 26.

FIG. 33 is a structural schematic diagram of a multi-color keyboard keycap with a protruding contour line provided by embodiment 8 of the application from a front view.

FIG. 34 is a structural schematic diagram of FIG. 33 from a rear view angle.

FIG. 35 is a structural schematic diagram of FIG. 33 from a left view angle.

FIG. 36 is a structural schematic diagram of FIG. 33 from a right view angle.

FIG. 37 is a structural schematic diagram of FIG. 33 from a top view angle.

FIG. 38 is a structural schematic diagram of FIG. 33 from a bottom view angle.

FIG. 39 is a three-dimensional diagram of FIG. 33.

FIG. 40 is a structural schematic diagram of a multi-color keyboard keycap with a protruding contour line provided by embodiment 9 of the application from a front view.

FIG. 41 is a structural schematic diagram of FIG. 40 from a rear view angle.

FIG. 42 is a structural schematic diagram of FIG. 40 from a left view angle.

FIG. 43 is a structural schematic diagram of FIG. 40 from a right view angle.

FIG. 44 is a structural schematic diagram of FIG. 40 from a top view angle.

FIG. 45 is a structural schematic diagram of FIG. 40 from a bottom view angle.

FIG. 46 is a three-dimensional diagram of FIG. 40.

FIG. 47 is a structural schematic diagram of a multi-color keyboard keycap with a protruding contour line provided by embodiment 10 of the application from a front view.

FIG. 48 is a structural schematic diagram of FIG. 47 from a rear view angle.

FIG. 49 is a structural schematic diagram of FIG. 47 from a left view angle.

FIG. 50 is a structural schematic diagram of FIG. 47 from a right view angle.

FIG. 51 is a structural schematic diagram of FIG. 47 from a top view angle.

FIG. 52 is a structural schematic diagram of FIG. 47 from a bottom view angle.

FIG. 53 is a three-dimensional diagram of FIG. 47.

FIG. 54 is a structural schematic diagram of a multi-color keyboard keycap with a protruding contour line provided by embodiment 11 of the application from a front view.

FIG. 55 is a structural schematic diagram of FIG. 54 from a rear view angle.

FIG. 56 is a structural schematic diagram of FIG. 54 from a left view angle.

FIG. 57 is a structural schematic diagram of FIG. 54 from a right view angle.

FIG. 58 is a structural schematic diagram of FIG. 54 from a top view angle.

FIG. 59 is a structural schematic diagram of FIG. 54 from a bottom view angle.

FIG. 60 is a three-dimensional diagram of FIG. 54.

FIG. 61 is a structural schematic diagram of a multi-color keyboard keycap with a protruding contour line provided by embodiment 12 of the application from a front view.

FIG. 62 is a structural schematic diagram of FIG. 61 from a rear view angle.

FIG. 63 is a structural schematic diagram of FIG. 61 from a left view angle.

FIG. 64 is a structural schematic diagram of FIG. 61 from a right view angle.

FIG. 65 is a structural schematic diagram of FIG. 61 from a top view angle.

FIG. 66 is a structural schematic diagram of FIG. 61 from a bottom view angle.

FIG. 67 is a three-dimensional diagram of FIG. 61.

FIG. 68 is a structural schematic diagram of a multi-color keyboard keycap with a protruding contour line provided by embodiment 13 of the application from a front view.

FIG. 69 is a structural schematic diagram of FIG. 68 from a rear view angle.

FIG. 70 is a structural schematic diagram of FIG. 68 from a left view angle.

FIG. 71 is a structural schematic diagram of FIG. 68 from a right view angle.

FIG. 72 is a structural schematic diagram of FIG. 68 from a top view angle.

FIG. 73 is a structural schematic diagram of FIG. 68 from a bottom view angle.

FIG. 74 is a three-dimensional diagram of FIG. 68.

FIG. 75 is a structural schematic diagram of a multi-color keyboard keycap with a protruding contour line provided by embodiment 14 of the application from a front view.

FIG. 76 is a structural schematic diagram of FIG. 75 from a rear view angle.

FIG. 77 is a structural schematic diagram of FIG. 75 from a left view angle.

FIG. 78 is a structural schematic diagram of FIG. 75 from a right view angle.

FIG. 79 is a structural schematic diagram of FIG. 75 from a top view angle.

FIG. 80 is a structural schematic diagram of FIG. 75 from a bottom view angle.

FIG. 81 is a three-dimensional diagram of FIG. 75.

FIG. 82 is a structural schematic diagram of a multi-color keyboard keycap with a protruding contour line provided by embodiment 15 of the application from a front view.

FIG. 83 is a structural schematic diagram of FIG. 82 from a rear view angle.

FIG. 84 is a structural schematic diagram of FIG. 82 from a left view angle.

FIG. 85 is a structural schematic diagram of FIG. 82 from a right view angle.

FIG. 86 is a structural schematic diagram of FIG. 82 from a top view angle.

FIG. 87 is a structural schematic diagram of FIG. 82 from a bottom view angle.

FIG. 88 is a three-dimensional diagram of FIG. 82.

FIG. 89 is a structural schematic diagram of a multi-color keyboard keycap with a protruding contour line provided by embodiment 16 of the application from a front view.

FIG. 90 is a structural schematic diagram of FIG. 89 from a rear view angle.

FIG. 91 is a structural schematic diagram of FIG. 89 from a left view angle.

FIG. 92 is a structural schematic diagram of FIG. 89 from a right view angle.

FIG. 93 is a structural schematic diagram of FIG. 89 from a top view angle.

FIG. 94 is a structural schematic diagram of FIG. 89 from a bottom view angle.

FIG. 95 is a three-dimensional diagram of FIG. 89.

FIG. 96 is a structural schematic diagram of a multi-color keyboard keycap with a protruding contour line provided by embodiment 17 of the application from a front view.

FIG. 97 is a structural schematic diagram of FIG. 96 from a rear view angle.

FIG. 98 is a structural schematic diagram of FIG. 96 from a left view angle.

FIG. 99 is a structural schematic diagram of FIG. 96 from a right view angle.

FIG. 100 is a structural schematic diagram of FIG. 96 from a top view angle.

FIG. 101 is a structural schematic diagram of FIG. 96 from a bottom view angle.

FIG. 102 is a three-dimensional diagram of FIG. 96.

FIG. 96 is a structural schematic diagram of a multi-color keyboard keycap with a protruding contour line provided by embodiment 18 of the application from a front view.

FIG. 97 is a structural schematic diagram of FIG. 96 from a rear view angle.

FIG. 98 is a structural schematic diagram of FIG. 96 from a left view angle.

FIG. 99 is a structural schematic diagram of FIG. 96 from a right view angle.

FIG. 100 is a structural schematic diagram of FIG. 96 from a top view angle.

FIG. 101 is a structural schematic diagram of FIG. 96 from a bottom view angle.

FIG. 102 is a three-dimensional diagram of FIG. 96.

FIG. 103 is a structural schematic diagram of a multi-color keyboard keycap with a protruding contour line provided by embodiment 19 of the application from a front view.

FIG. 104 is a structural schematic diagram of FIG. 103 from a rear view angle.

FIG. 105 is a structural schematic diagram of FIG. 103 from a left view angle.

FIG. 106 is a structural schematic diagram of FIG. 103 from a right view angle.

FIG. 107 is a structural schematic diagram of FIG. 103 from a top view angle.

FIG. 108 is a structural schematic diagram of FIG. 103 from a bottom view angle.

FIG. 109 is a three-dimensional diagram of FIG. 103.

FIG. 110 is a structural schematic diagram of a multi-color keyboard keycap with a protruding contour line provided by embodiment 20 of the application from a front view.

FIG. 111 is a structural schematic diagram of FIG. 110 from a rear view angle.

FIG. 112 is a structural schematic diagram of FIG. 110 from a left view angle.

FIG. 113 is a structural schematic diagram of FIG. 110 from a right view angle.

FIG. 114 is a structural schematic diagram of FIG. 110 from a top view angle.

FIG. 115 is a structural schematic diagram of FIG. 110 from a bottom view angle.

FIG. 116 is a three-dimensional diagram of FIG. 110.

FIG. 117 is a structural schematic diagram of a multi-color keyboard keycap with a protruding contour line provided by embodiment 21 of the application from a front view.

FIG. 118 is a structural schematic diagram of FIG. 117 from a rear view angle.

FIG. 119 is a structural schematic diagram of FIG. 117 from a left view angle.

FIG. 120 is a structural schematic diagram of FIG. 117 from a right view angle.

FIG. 121 is a structural schematic diagram of FIG. 117 from a top view angle.

FIG. 122 is a structural schematic diagram of FIG. 117 from a bottom view angle.

FIG. 123 is a three-dimensional diagram of FIG. 117.

FIG. 124 is a structural schematic diagram of a multi-color keyboard keycap with a protruding contour line provided by embodiment 22 of the application from a front view.

FIG. 125 is a structural schematic diagram of FIG. 124 from a rear view angle.

FIG. 126 is a structural schematic diagram of FIG. 124 from a left view angle.

FIG. 127 is a structural schematic diagram of FIG. 124 from a right view angle.

FIG. 128 is a structural schematic diagram of FIG. 124 from a top view angle.

FIG. 129 is a structural schematic diagram of FIG. 124 from a bottom view angle.

FIG. 130 is a three-dimensional diagram of FIG. 124.

FIG. 131 is a structural schematic diagram of a multi-color keyboard keycap with a protruding contour line provided by embodiment 23 of the application from a front view.

FIG. 132 is a structural schematic diagram of FIG. 131 from a rear view angle.

FIG. 133 is a structural schematic diagram of FIG. 131 from a left view angle.

FIG. 134 is a structural schematic diagram of FIG. 131 from a right view angle.

FIG. 135 is a structural schematic diagram of FIG. 131 from a top view angle.

FIG. 136 is a structural schematic diagram of FIG. 131 from a bottom view angle.

FIG. 137 is a three-dimensional diagram of FIG. 131.

FIG. 138 is a structural schematic diagram of a multi-color keyboard keycap with a protruding contour line provided by embodiment 24 of the application from a front view.

FIG. 139 is a structural schematic diagram of FIG. 138 from a rear view angle.

FIG. 140 is a structural schematic diagram of FIG. 138 from a left view angle.

FIG. 141 is a structural schematic diagram of FIG. 138 from a right view angle.

FIG. 142 is a structural schematic diagram of FIG. 138 from a top view angle.

FIG. 143 is a structural schematic diagram of FIG. 138 from a bottom view angle.

FIG. 144 is a three-dimensional diagram of FIG. 138.

FIG. 145 is a structural schematic diagram of a multi-color keyboard keycap with a protruding contour line provided by embodiment 25 of the application from a front view.

FIG. 146 is a structural schematic diagram of FIG. 145 from a rear view angle.

FIG. 147 is a structural schematic diagram of FIG. 145 from a left view angle.

FIG. 148 is a structural schematic diagram of FIG. 145 from a right view angle.

FIG. 149 is a structural schematic diagram of FIG. 145 from a top view angle.

FIG. 150 is a structural schematic diagram of FIG. 145 from a bottom view angle.

FIG. 151 is a three-dimensional diagram of FIG. 145.

FIG. 152 is a structural schematic diagram of a multi-color keyboard keycap with a protruding contour line provided by embodiment 26 of the application from a front view.

FIG. 153 is a structural schematic diagram of FIG. 152 from a rear view angle.

FIG. 154 is a structural schematic diagram of FIG. 152 from a left view angle.

FIG. 155 is a structural schematic diagram of FIG. 152 from a right view angle.

FIG. 156 is a structural schematic diagram of FIG. 152 from a top view angle.

FIG. 157 is a structural schematic diagram of FIG. 152 from a bottom view angle.

FIG. 158 is a three-dimensional diagram of FIG. 152.

FIG. 1A is a structural schematic diagram of a multi-color keyboard keycap with a protruding contour line provided by embodiment 27 of the application from a front view.

FIG. 1B is a structural schematic diagram of FIG. 1A from a rear view angle.

FIG. 1C is a structural schematic diagram of FIG. 1A from a left view angle.

FIG. 1D is a structural schematic diagram of FIG. 1A from a right view angle.

FIG. 1E is a structural schematic diagram of FIG. 1A from a top view angle.

FIG. 1F is a structural schematic diagram of FIG. 1A from a bottom view angle.

FIG. 1G is a three-dimensional diagram of FIG. 1A.

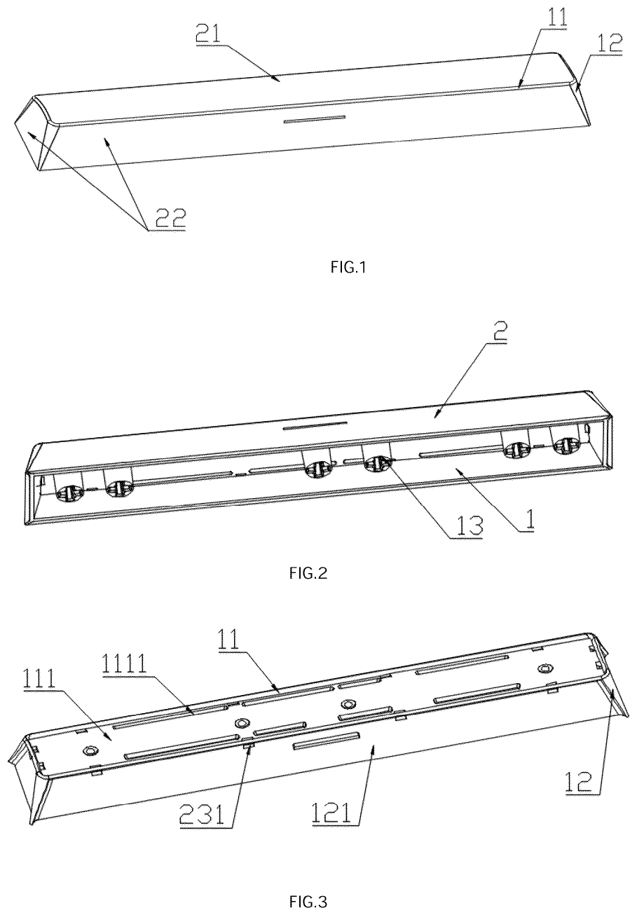

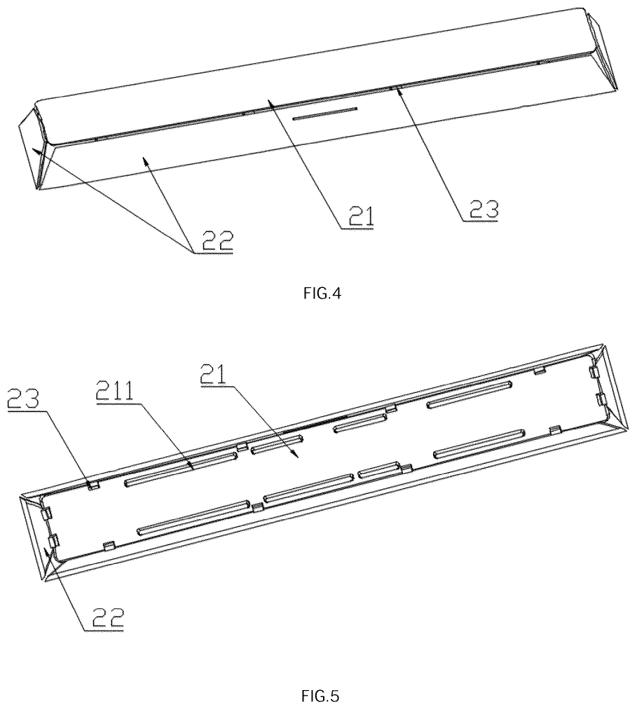

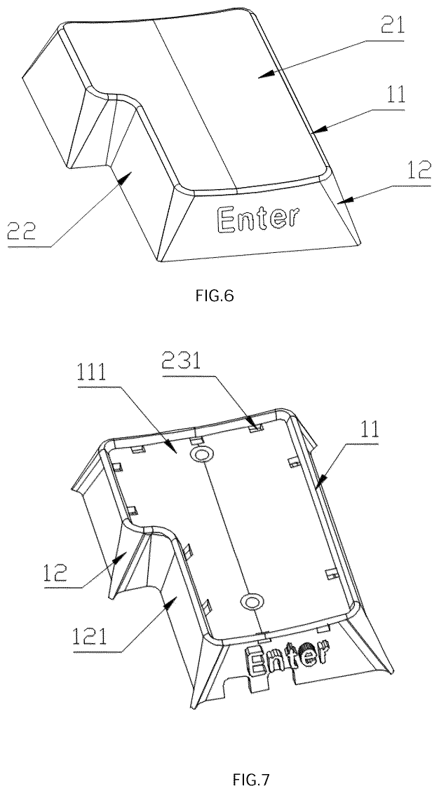

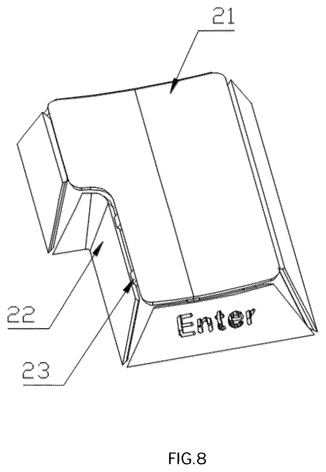

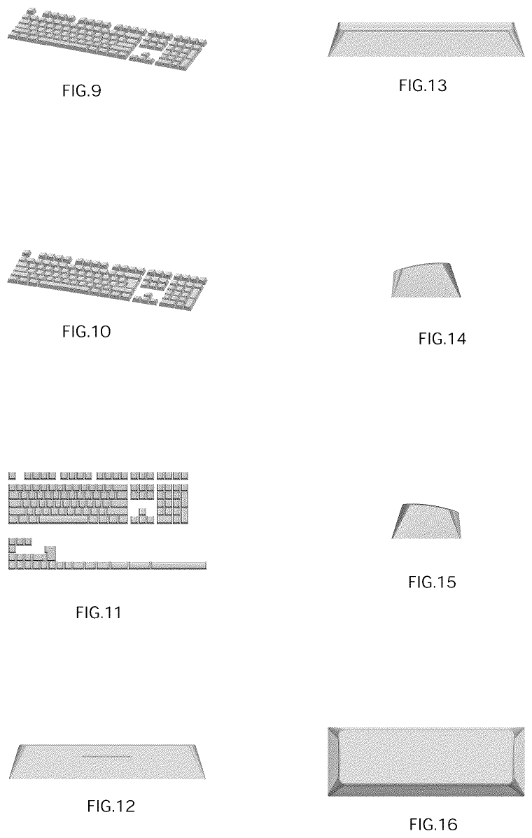

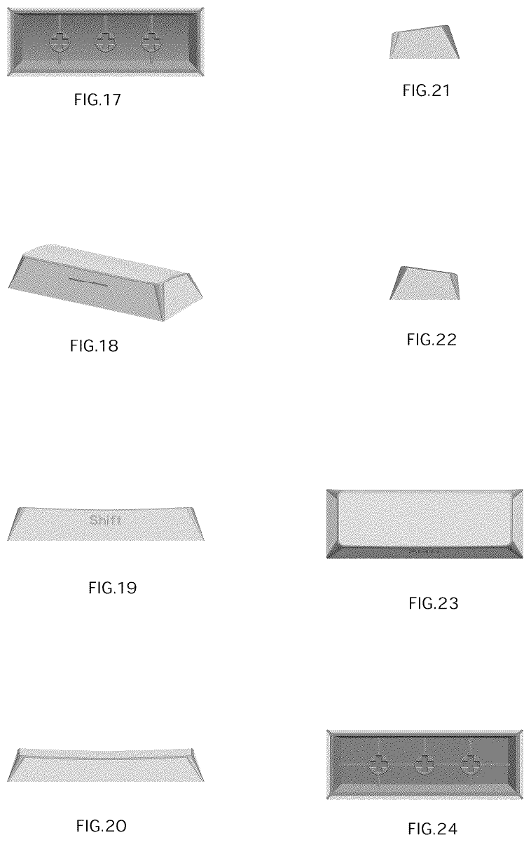

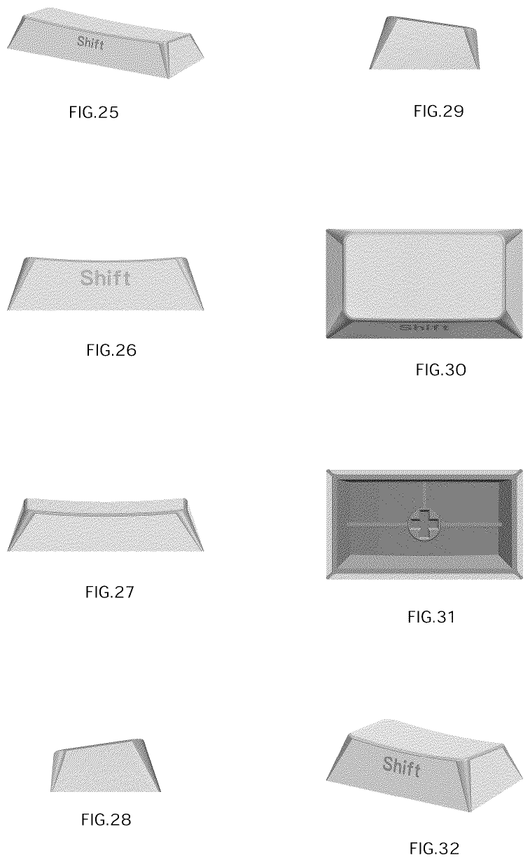

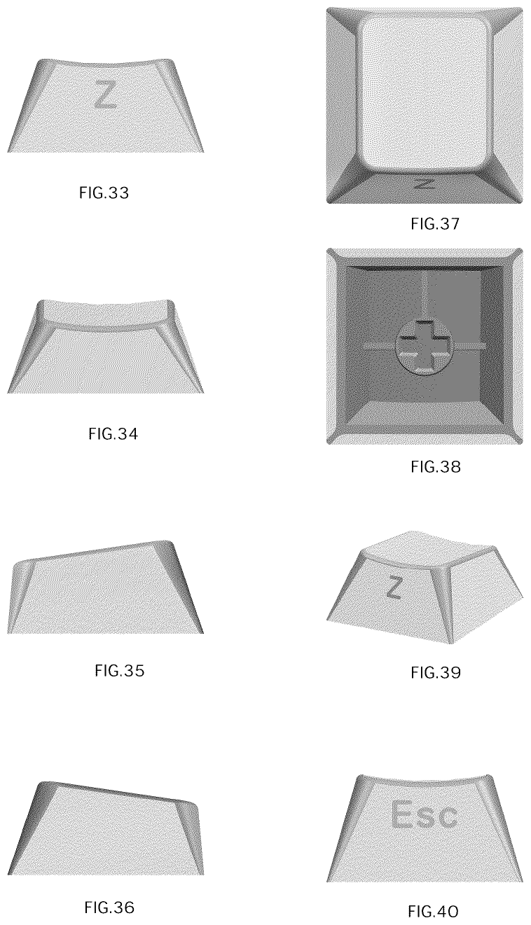

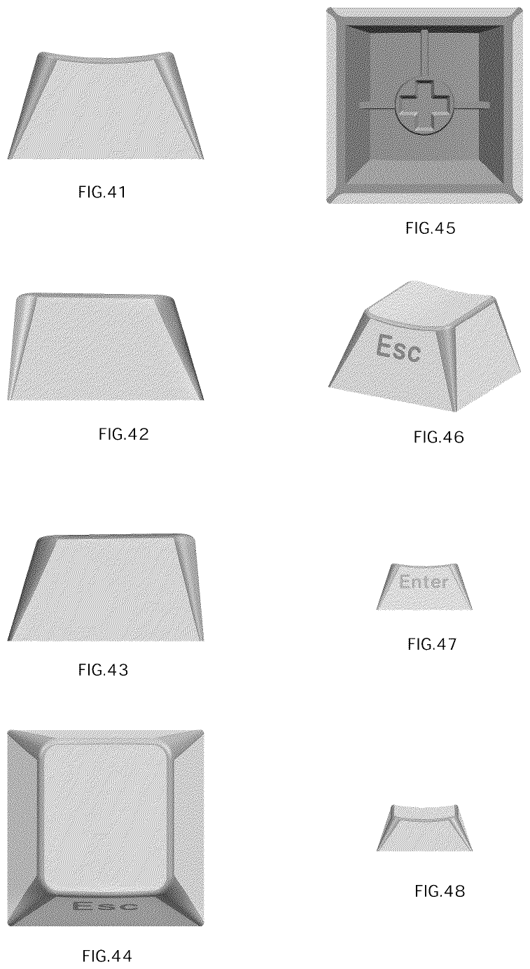

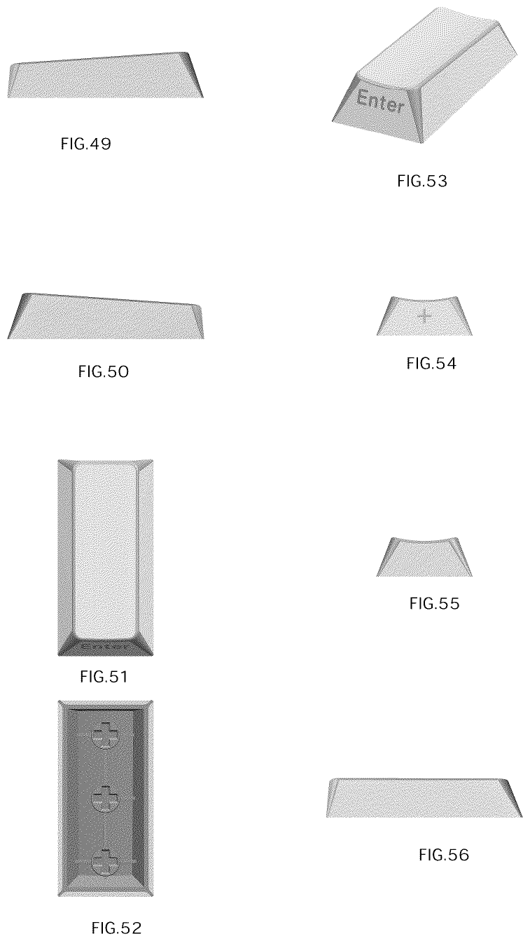

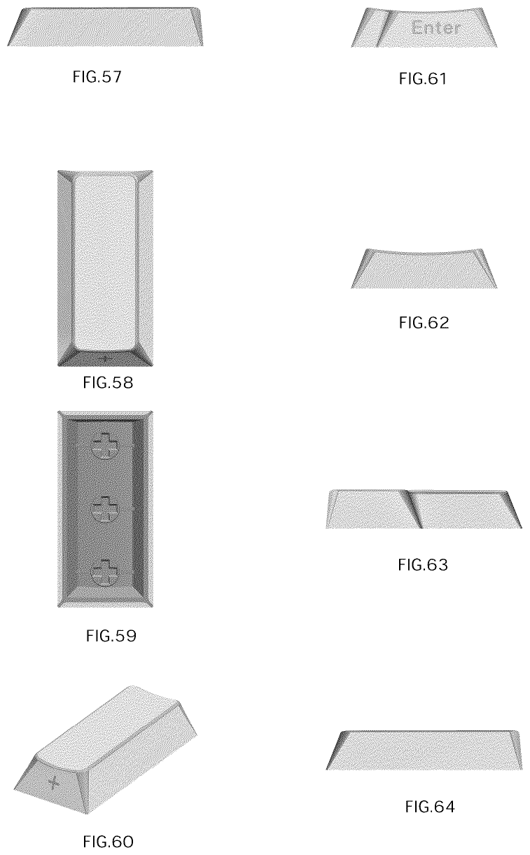

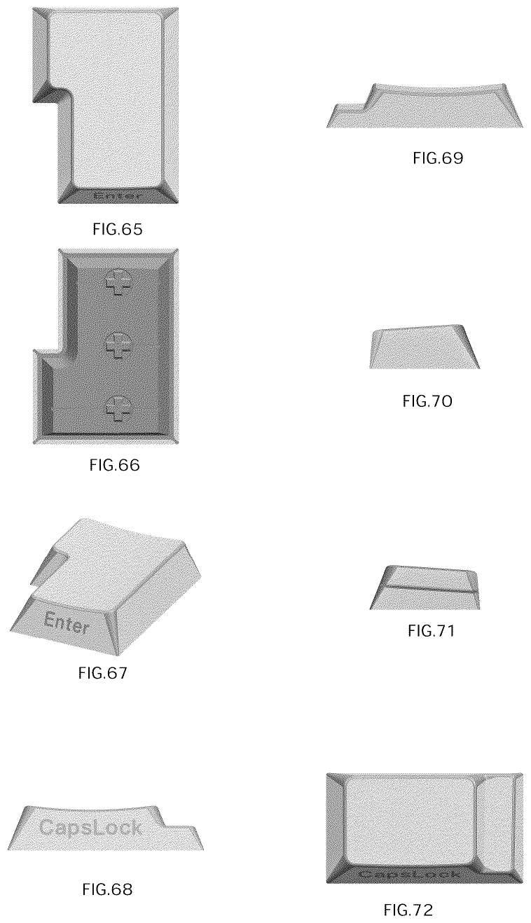

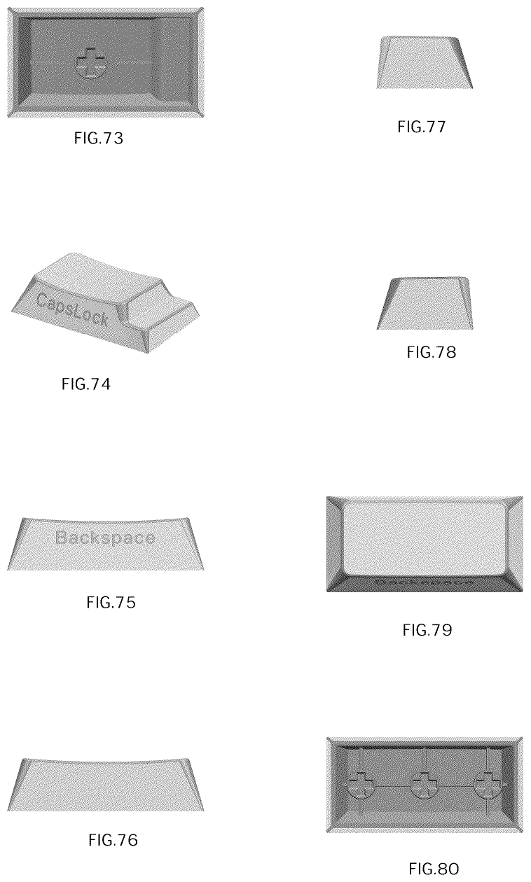

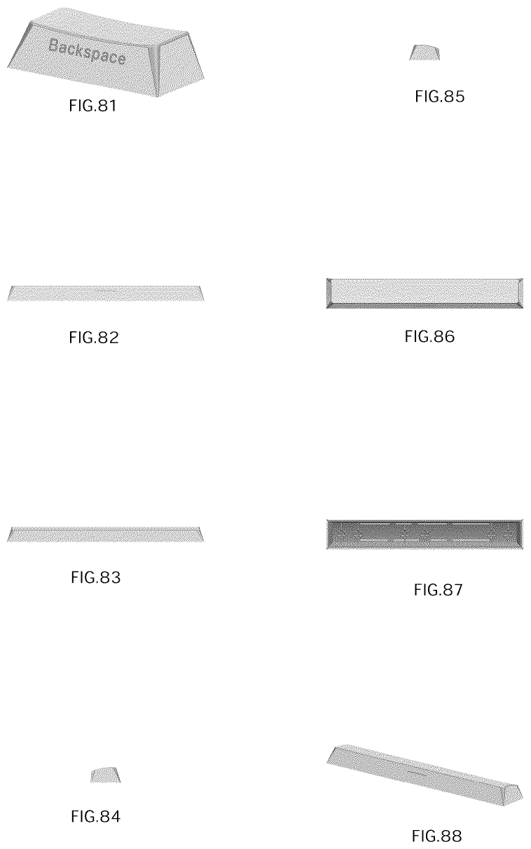

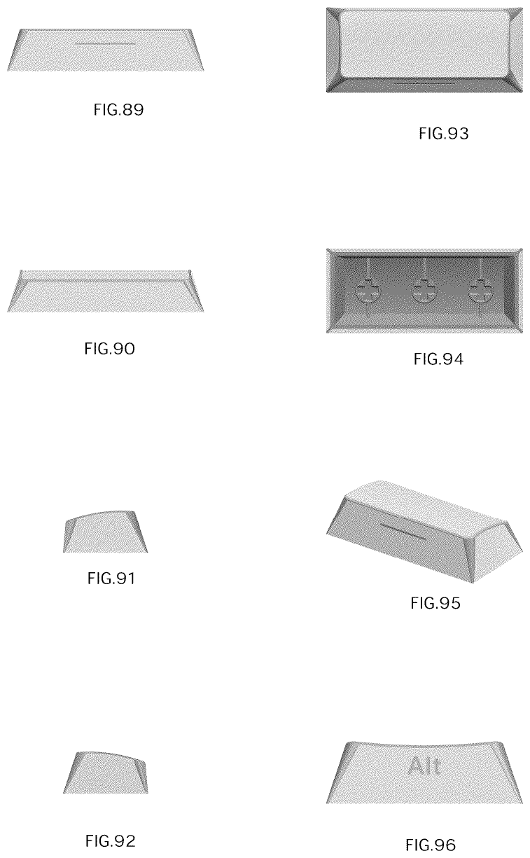

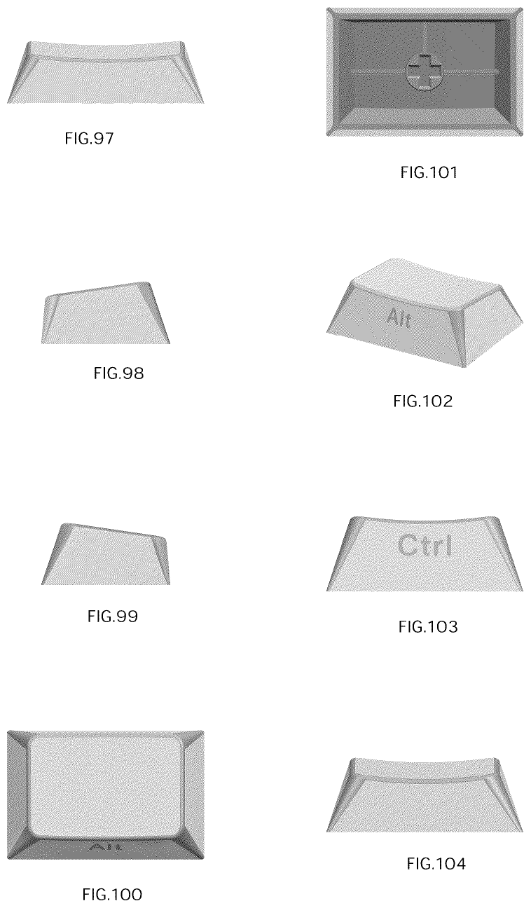

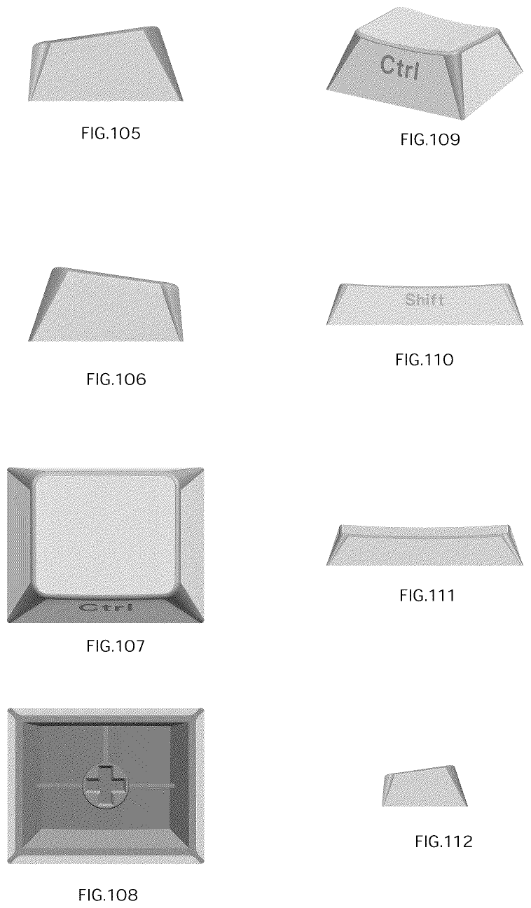

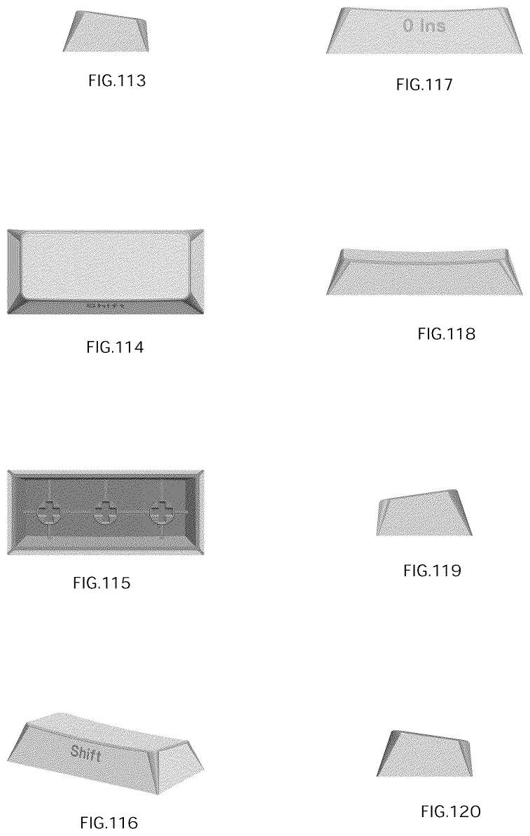

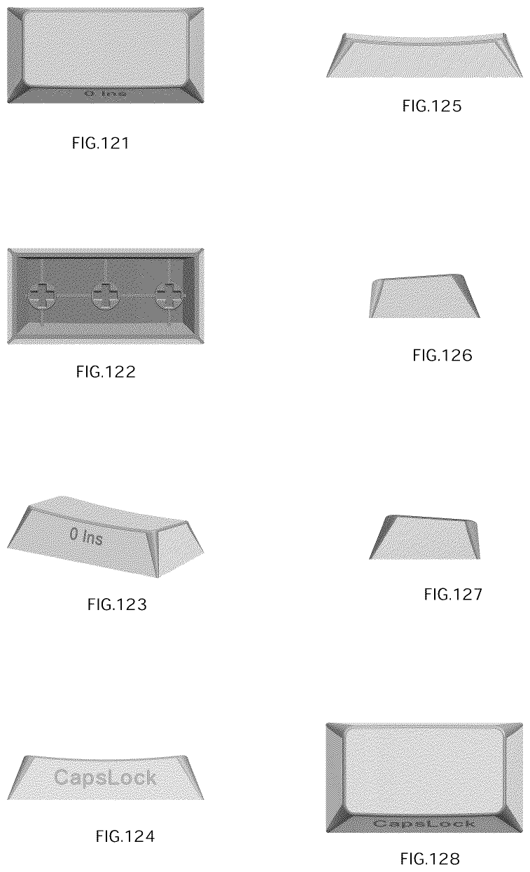

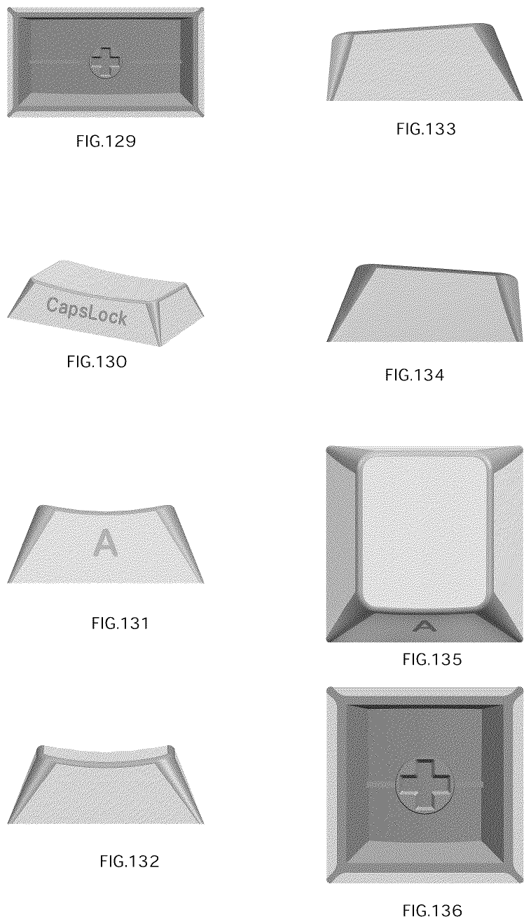

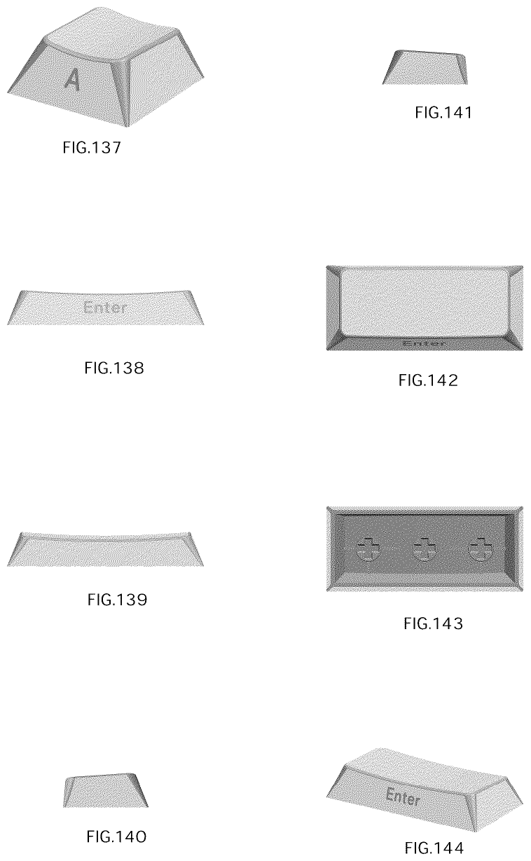

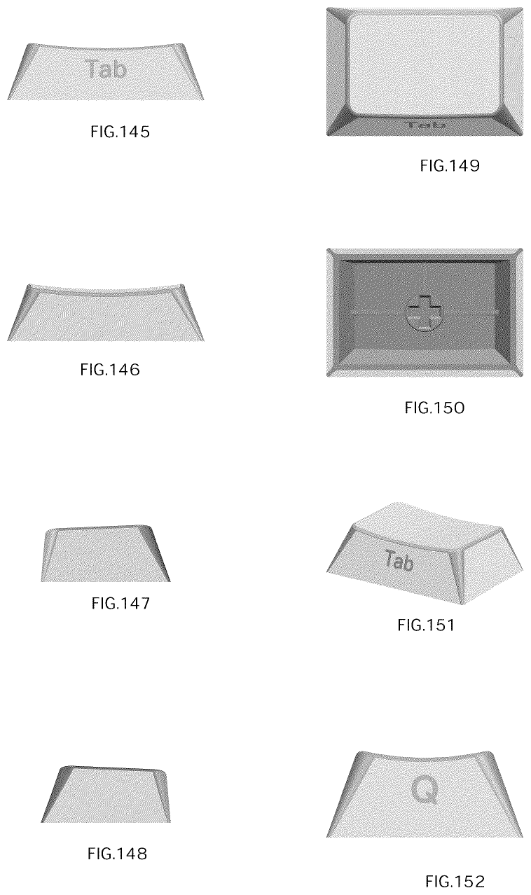

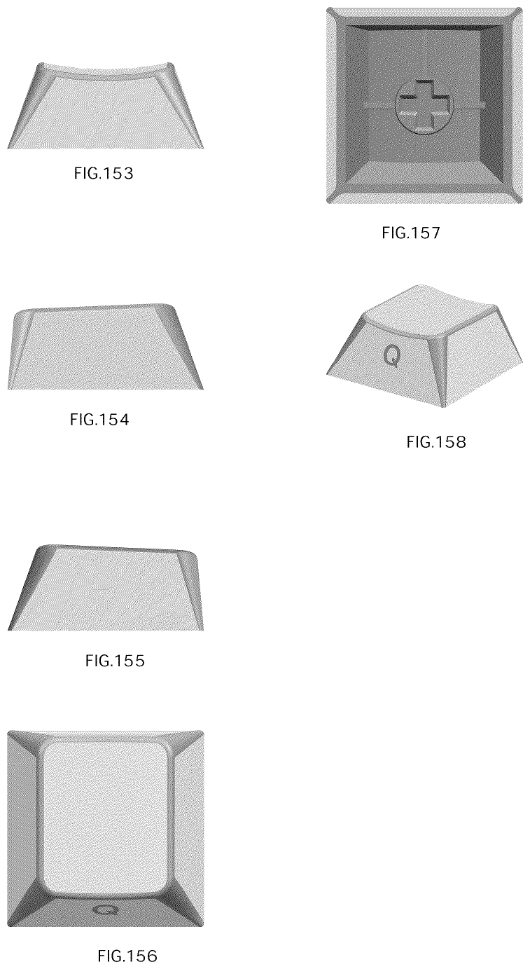

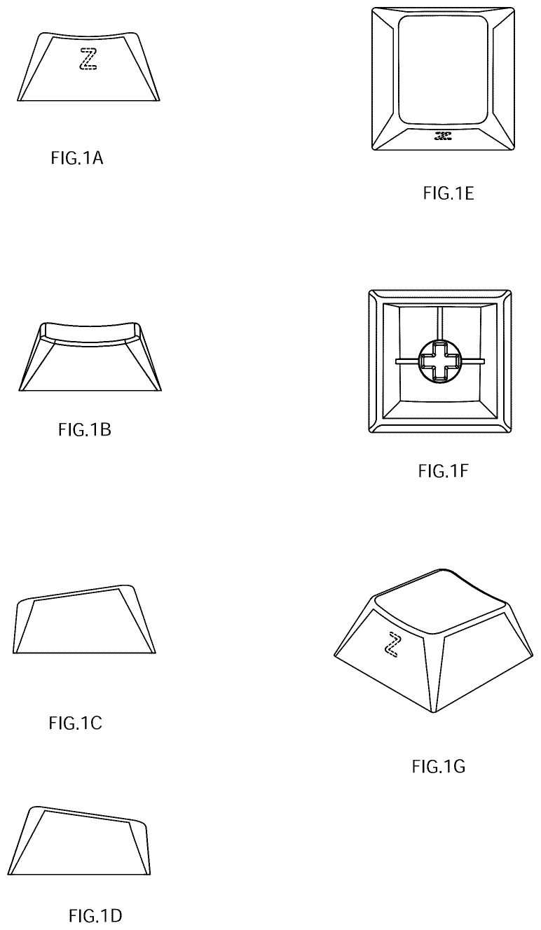

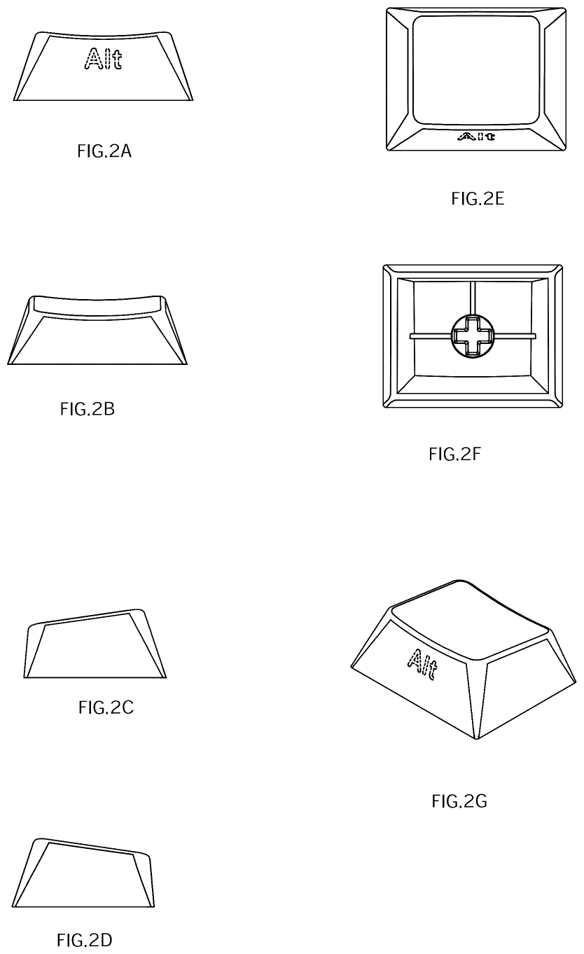

FIG. 2A is a structural schematic diagram of a multi-color keyboard keycap with a protruding contour line provided by embodiment 28 of the application from a front view.

FIG. 2B is a structural schematic diagram of FIG. 2A from a rear view angle.

FIG. 2C is a structural schematic diagram of FIG. 2A from a left view angle.

FIG. 2D is a structural schematic diagram of FIG. 2A from a right view angle.

FIG. 2E is a structural schematic diagram of FIG. 2A from a top view angle.

FIG. 2F is a structural schematic diagram of FIG. 2A from a bottom view angle.

FIG. 2G is a three-dimensional diagram of FIG. 2A.

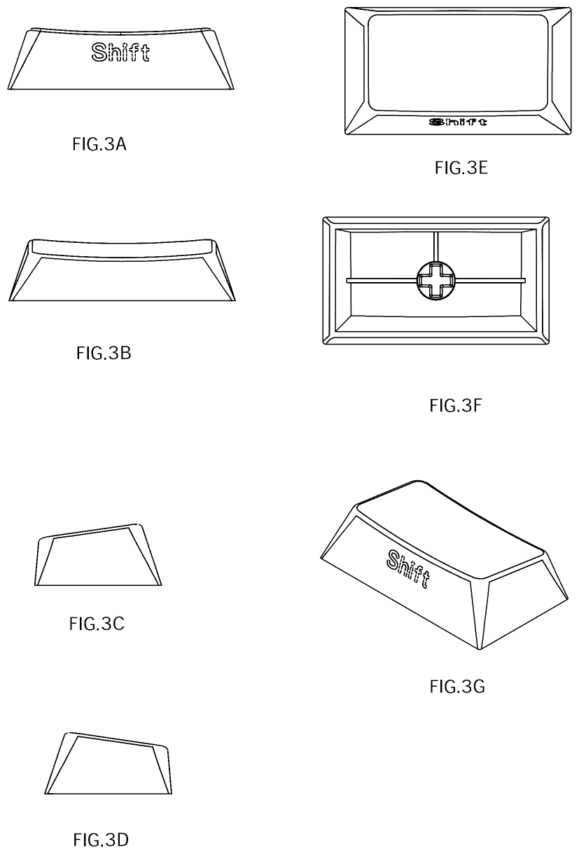

FIG. 3A is a structural schematic diagram of a multi-color keyboard keycap with a protruding contour line provided by embodiment 29 of the application from a front view.

FIG. 3B is a structural schematic diagram of FIG. 3A from a rear view angle.

FIG. 3C is a structural schematic diagram of FIG. 3A from a left view angle.

FIG. 3D is a structural schematic diagram of FIG. 3A from a right view angle.

FIG. 3E is a structural schematic diagram of FIG. 3A from a top view angle.

FIG. 3F is a structural schematic diagram of FIG. 3A from a bottom view angle.

FIG. 3G is a three-dimensional diagram of FIG. 3A.

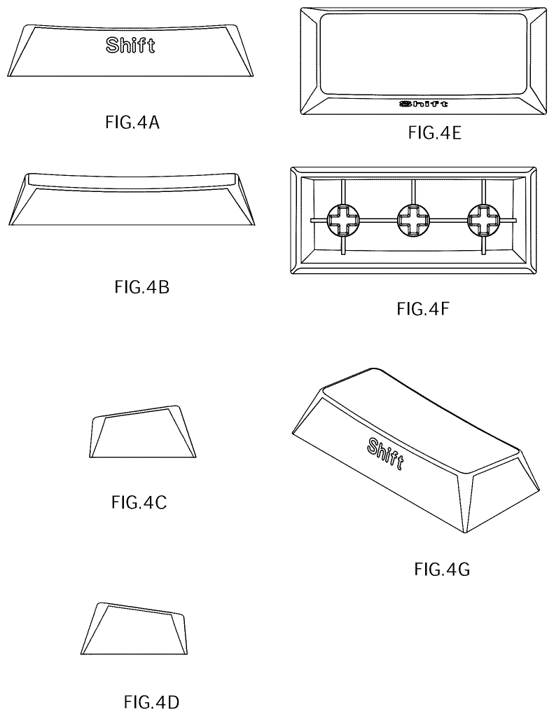

FIG. 4A is a structural schematic diagram of a multi-color keyboard keycap with a protruding contour line provided by embodiment 30 of the application from a front view.

FIG. 4B is a structural schematic diagram of FIG. 4A from a rear view angle.

FIG. 4C is a structural schematic diagram of FIG. 4A from a left view angle.

FIG. 4D is a structural schematic diagram of FIG. 4A from a right view angle.

FIG. 4E is a structural schematic diagram of FIG. 4A from a top view angle.

FIG. 4F is a structural schematic diagram of FIG. 4A from a bottom view angle.

FIG. 4G is a three-dimensional diagram of FIG. 4A.

FIG. 5A is a structural schematic diagram of a multi-color keyboard keycap with a protruding contour line provided by embodiment 31 of the application from a front view.

FIG. 5B is a structural schematic diagram of FIG. 5A from a rear view angle.

FIG. 5C is a structural schematic diagram of FIG. 5A from a left view angle.

FIG. 5D is a structural schematic diagram of FIG. 5A from a right view angle.

FIG. 5E is a structural schematic diagram of FIG. 5A from a top view angle.

FIG. 5F is a structural schematic diagram of FIG. 5A from a bottom view angle.

FIG. 5G is a three-dimensional diagram of FIG. 5A.

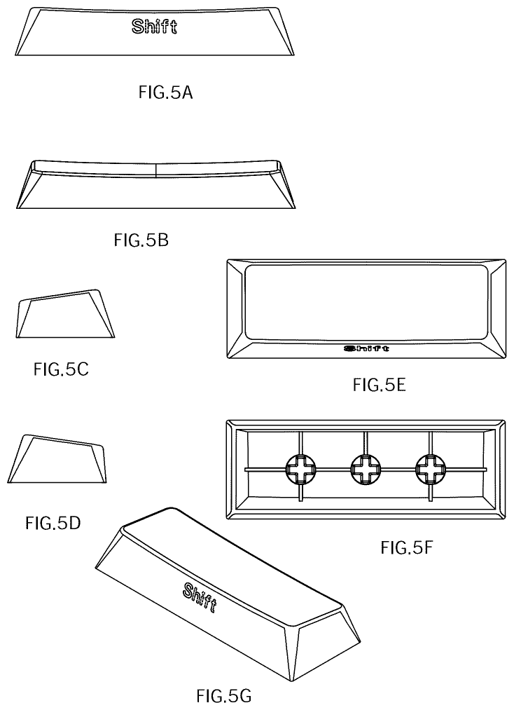

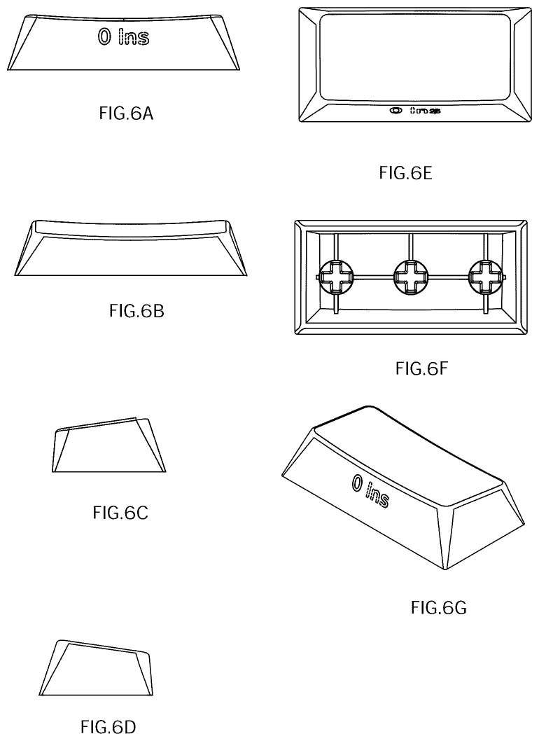

FIG. 6A is a structural schematic diagram of a multi-color keyboard keycap with a protruding contour line provided by embodiment 32 of the application from a front view.

FIG. 6B is a structural schematic diagram of FIG. 6A from a rear view angle.

FIG. 6C is a structural schematic diagram of FIG. 6A from a left view angle.

FIG. 6D is a structural schematic diagram of FIG. 6A from a right view angle.

FIG. 6E is a structural schematic diagram of FIG. 6A from a top view angle.

FIG. 6F is a structural schematic diagram of FIG. 6A from a bottom view angle.

FIG. 6G is a three-dimensional diagram of FIG. 6A.

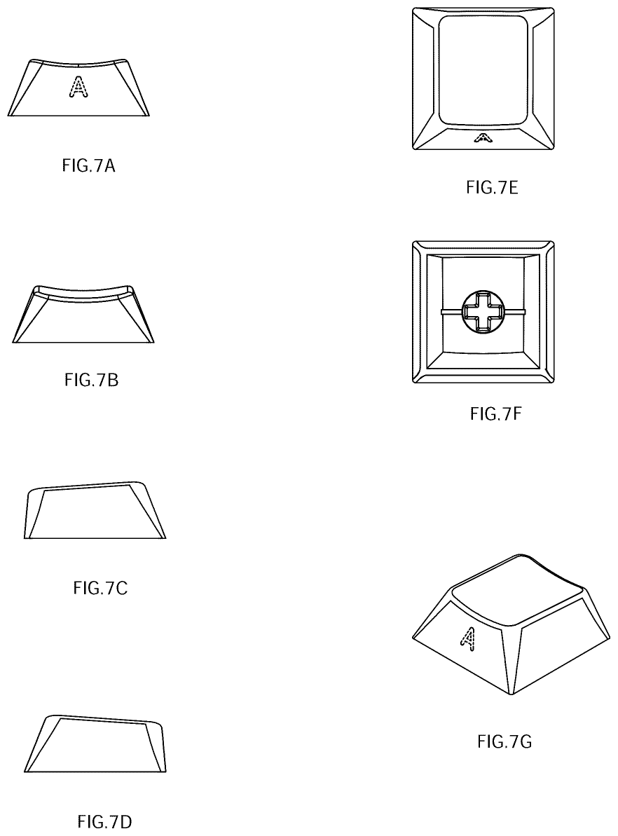

FIG. 7A is a structural schematic diagram of a multi-color keyboard keycap with a protruding contour line provided by embodiment 33 of the application from a front view.

FIG. 7B is a structural schematic diagram of FIG. 7A from a rear view angle.

FIG. 7C is a structural schematic diagram of FIG. 7A from a left view angle.

FIG. 7D is a structural schematic diagram of FIG. 7A from a right view angle.

FIG. 7E is a structural schematic diagram of FIG. 7A from a top view angle.

FIG. 7F is a structural schematic diagram of FIG. 7A from a bottom view angle.

FIG. 7G is a three-dimensional diagram of FIG. 7A.

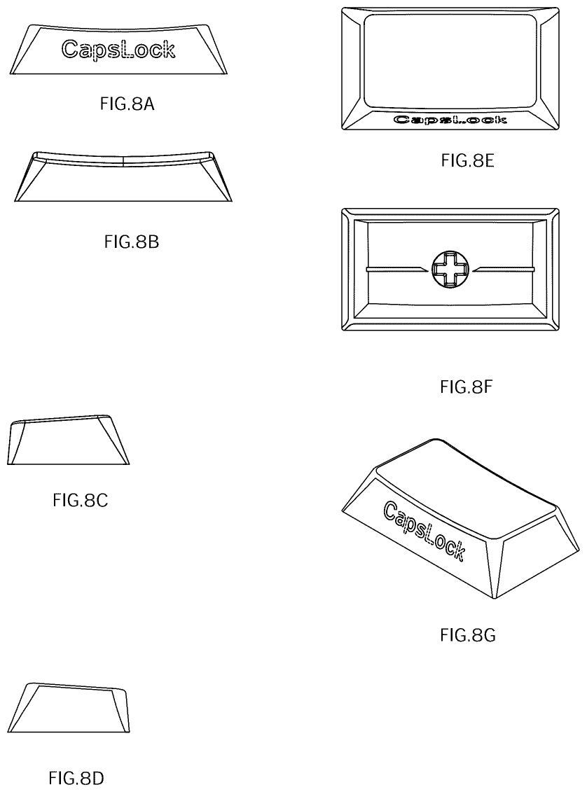

FIG. 8A is a structural schematic diagram of a multi-color keyboard keycap with a protruding contour line provided by embodiment 34 of the application from a front view.

FIG. 8B is a structural schematic diagram of FIG. 8A from a rear view angle.

FIG. 8C is a structural schematic diagram of FIG. 8A from a left view angle.

FIG. 8D is a structural schematic diagram of FIG. 8A from a right view angle.

FIG. 8E is a structural schematic diagram of FIG. 8A from a top view angle.

FIG. 8F is a structural schematic diagram of FIG. 8A from a bottom view angle.

FIG. 8G is a three-dimensional diagram of FIG. 8A.

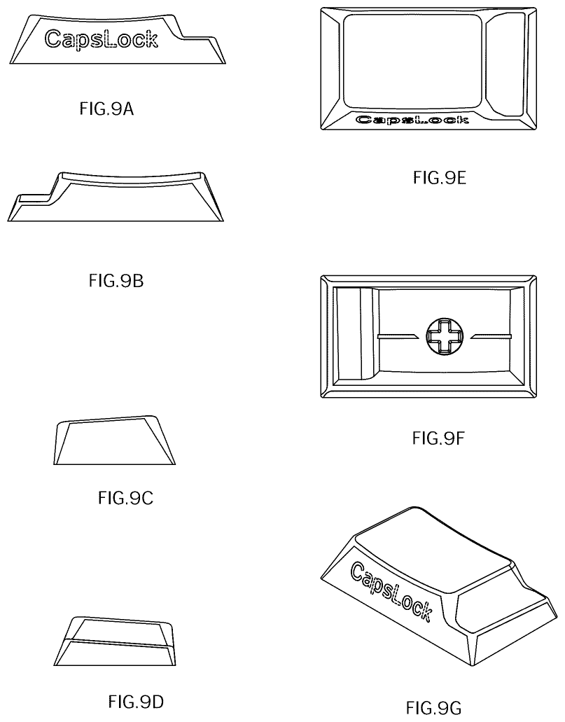

FIG. 9A is a structural schematic diagram of a multi-color keyboard keycap with a protruding contour line provided by embodiment 35 of the application from a front view.

FIG. 9B is a structural schematic diagram of FIG. 9A from a rear view angle.

FIG. 9C is a structural schematic diagram of FIG. 9A from a left view angle.

FIG. 9D is a structural schematic diagram of FIG. 9A from a right view angle.

FIG. 9E is a structural schematic diagram of FIG. 9A from a top view angle.

FIG. 9F is a structural schematic diagram of FIG. 9A from a bottom view angle.

FIG. 9G is a three-dimensional diagram of FIG. 9A.

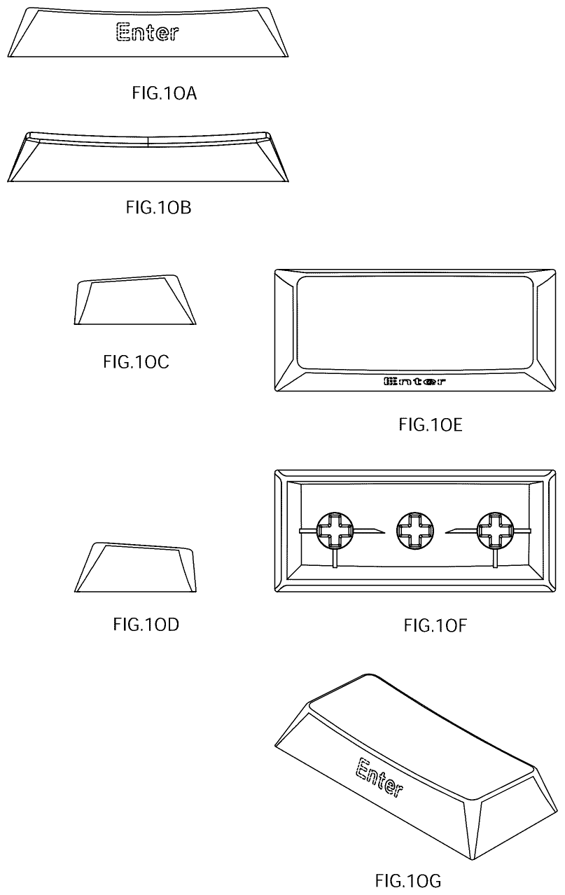

FIG. 10A is a structural schematic diagram of a multi-color keyboard keycap with a protruding contour line provided by embodiment 36 of the application from a front view.

FIG. 10B is a structural schematic diagram of FIG. 10A from a rear view angle.

FIG. 10C is a structural schematic diagram of FIG. 10A from a left view angle.

FIG. 10D is a structural schematic diagram of FIG. 10A from a right view angle.

FIG. 10E is a structural schematic diagram of FIG. 10A from a top view angle.

FIG. 10F is a structural schematic diagram of FIG. 10A from a bottom view angle.

FIG. 10G is a three-dimensional diagram of FIG. 10A.

FIG. 11A is a structural schematic diagram of a multi-color keyboard keycap with a protruding contour line provided by embodiment 37 of the application from a front view.

FIG. 11B is a structural schematic diagram of FIG. 11A from a rear view angle.

FIG. 11C is a structural schematic diagram of FIG. 11A from a left view angle.

FIG. 11D is a structural schematic diagram of FIG. 11A from a right view angle.

FIG. 11E is a structural schematic diagram of FIG. 11A from a top view angle.

FIG. 11F is a structural schematic diagram of FIG. 11A from a bottom view angle.

FIG. 11G is a three-dimensional diagram of FIG. 11A.

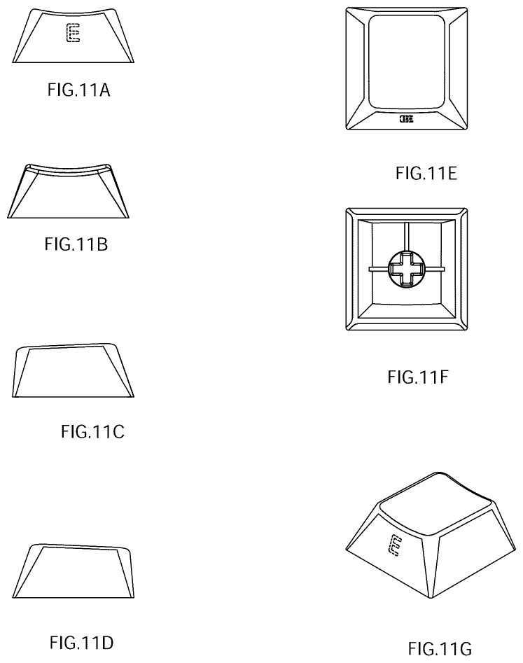

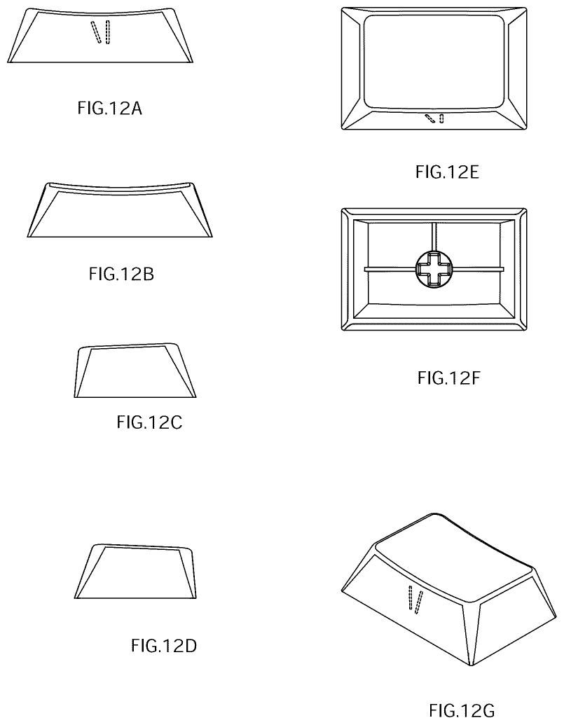

FIG. 12A is a structural schematic diagram of a multi-color keyboard keycap with a protruding contour line provided by embodiment 38 of the application from a front view.

FIG. 12B is a structural schematic diagram of FIG. 12A from a rear view angle.

FIG. 12C is a structural schematic diagram of FIG. 12A from a left view angle.

FIG. 12D is a structural schematic diagram of FIG. 12A from a right view angle.

FIG. 12E is a structural schematic diagram of FIG. 12A from a top view angle.

FIG. 12F is a structural schematic diagram of FIG. 12A from a bottom view angle.

FIG. 12G is a three-dimensional diagram of FIG. 12A.

FIG. 13A is a structural schematic diagram of a multi-color keyboard keycap with a protruding contour line provided by embodiment 39 of the application from a front view.

FIG. 13B is a structural schematic diagram of FIG. 13A from a rear view angle.

FIG. 13C is a structural schematic diagram of FIG. 13A from a left view angle.

FIG. 13D is a structural schematic diagram of FIG. 13A from a right view angle.

FIG. 13E is a structural schematic diagram of FIG. 13A from a top view angle.

FIG. 13F is a structural schematic diagram of FIG. 13A from a bottom view angle.

FIG. 13G is a three-dimensional diagram of FIG. 13A.

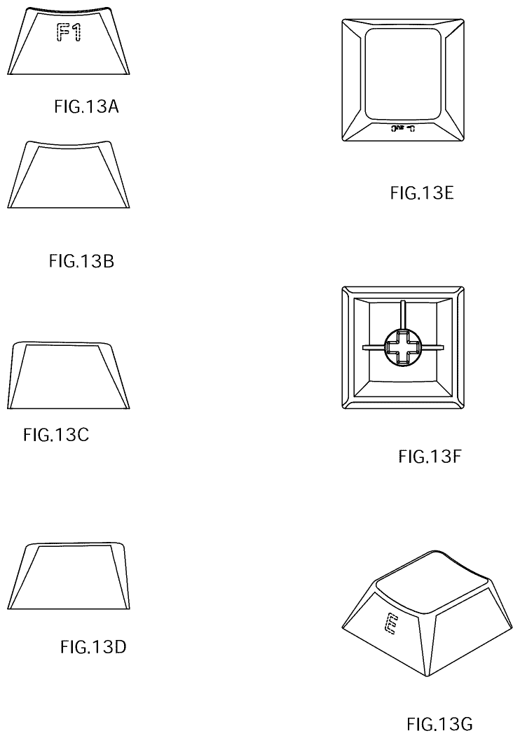

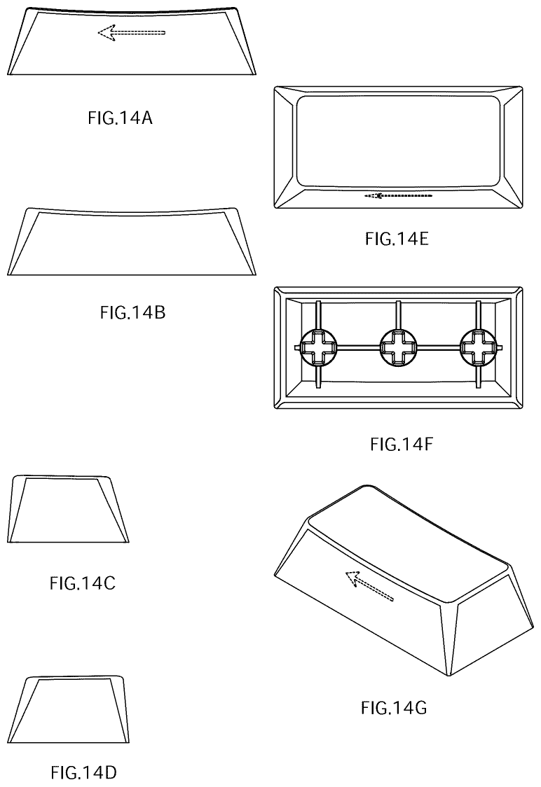

FIG. 14A is a structural schematic diagram of a multi-color keyboard keycap with a protruding contour line provided by embodiment 40 of the application from a front view.

FIG. 14B is a structural schematic diagram of FIG. 14A from a rear view angle.

FIG. 14C is a structural schematic diagram of FIG. 14A from a left view angle.

FIG. 14D is a structural schematic diagram of FIG. 14A from a right view angle.

FIG. 14E is a structural schematic diagram of FIG. 14A from a top view angle.

FIG. 14F is a structural schematic diagram of FIG. 14A from a bottom view angle.

FIG. 14G is a three-dimensional diagram of FIG. 14A.

FIG. 15A is a structural schematic diagram of a multi-color keyboard keycap with a protruding contour line provided by embodiment 41 of the application from a front view.

FIG. 15B is a structural schematic diagram of FIG. 15A from a rear view angle.

FIG. 15C is a structural schematic diagram of FIG. 15A from a left view angle.

FIG. 15D is a structural schematic diagram of FIG. 15A from a right view angle.

FIG. 15E is a structural schematic diagram of FIG. 15A from a top view angle.

FIG. 15F is a structural schematic diagram of FIG. 15A from a bottom view angle.

FIG. 15G is a three-dimensional diagram of FIG. 15A.

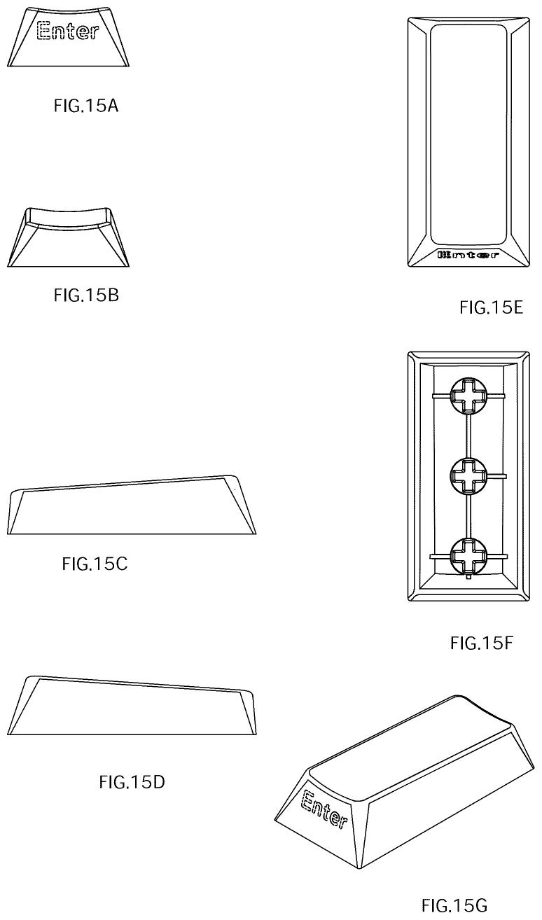

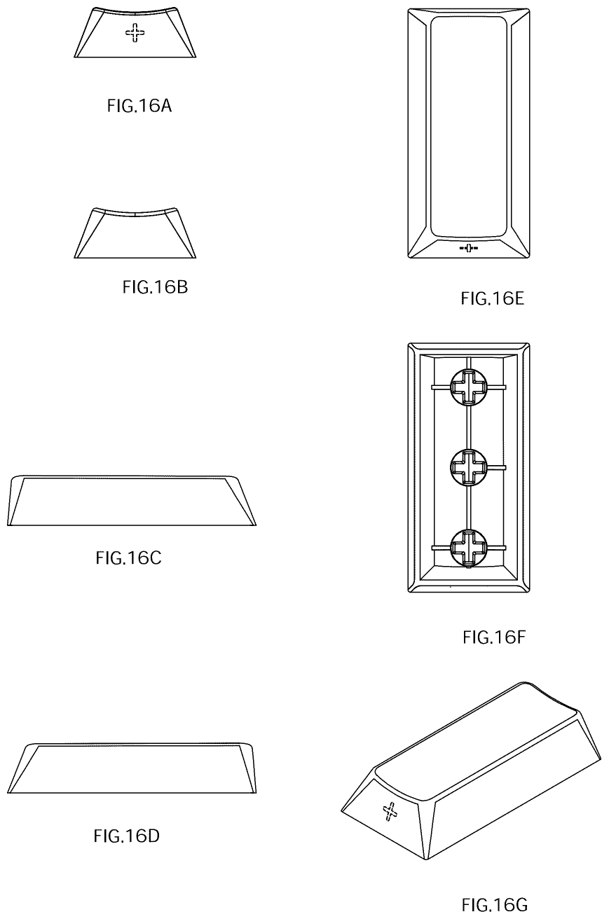

FIG. 16A is a structural schematic diagram of a multi-color keyboard keycap with a protruding contour line provided by embodiment 42 of the application from a front view.

FIG. 16B is a structural schematic diagram of FIG. 16A from a rear view angle.

FIG. 16C is a structural schematic diagram of FIG. 16A from a left view angle.

FIG. 16D is a structural schematic diagram of FIG. 16A from a right view angle.

FIG. 16E is a structural schematic diagram of FIG. 16A from a top view angle.

FIG. 16F is a structural schematic diagram of FIG. 16A from a bottom view angle.

FIG. 16G is a three-dimensional diagram of FIG. 16A.

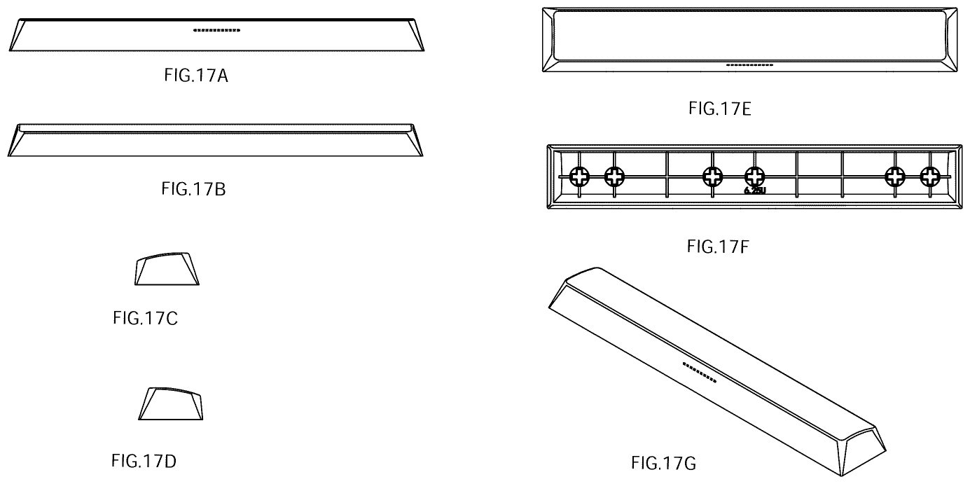

FIG. 17A is a structural schematic diagram of a multi-color keyboard keycap with a protruding contour line provided by embodiment 43 of the application from a front view.

FIG. 17B is a structural schematic diagram of FIG. 17A from a rear view angle.

FIG. 17C is a structural schematic diagram of FIG. 17A from a left view angle.

FIG. 17D is a structural schematic diagram of FIG. 17A from a right view angle.

FIG. 17E is a structural schematic diagram of FIG. 17A from a top view angle.

FIG. 17F is a structural schematic diagram of FIG. 17A from a bottom view angle.

FIG. 17G is a three-dimensional diagram of FIG. 17A.

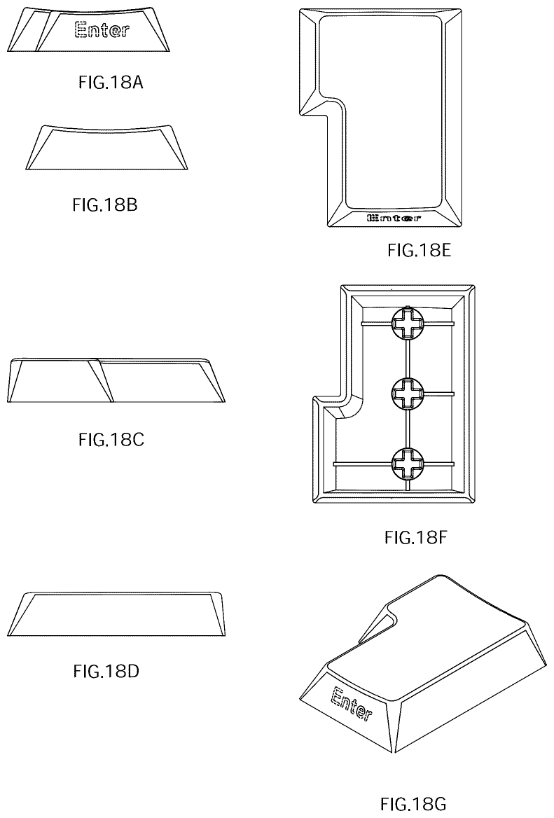

FIG. 18A is a structural schematic diagram of a multi-color keyboard keycap with a protruding contour line provided by embodiment 44 of the application from a front view.

FIG. 18B is a structural schematic diagram of FIG. 18A from a rear view angle.

FIG. 18C is a structural schematic diagram of FIG. 18A from a left view angle.

FIG. 18D is a structural schematic diagram of FIG. 18A from a right view angle.

FIG. 18E is a structural schematic diagram of FIG. 18A from a top view angle.

FIG. 18F is a structural schematic diagram of FIG. 18A from a bottom view angle.

FIG. 18G is a three-dimensional diagram of FIG. 18A.

Reference numeral descriptions: 1—cap base, 11—upper ring ridge, 111—top plate groove, 1111—strip-shaped reinforcing hole, 12—edge ridge, 121—side plate groove, 13—connecting post, 2—cap cover, 21—top plate, 211—strip-shaped reinforcing rib, 22—side plate, 23—connecting block.

### DETAILED DESCRIPTION OF THE EMBODIMENTS

The technical solutions in the embodiments of the application will be clearly and completely described below in conjunction with the drawings in the embodiments of the application. Obviously, the described embodiments are only a part of the embodiments of the application, not all of the embodiments. Based on the embodiments in the application, all other embodiments obtained by a person of ordinary skill in the art without creative labor fall within a protection scope of the application.

### Embodiment 1

As shown in FIG. 1 to FIG. 8, the present embodiment provides a multi-color keyboard keycap with a protruding contour line, including: a cap base 1 and a cap cover 2 connected to each other, the cap base 1 and the cap cover 2 are both cap-shaped with a bottom opening, the cap cover 2 is installed on an outer side of the cap base 1; during an actual production, the cap base 1 and the cap cover 2 are both injection molded, first a cap base mold and a cap cover mold are mutually matched, which can realize first injection molding the cap base 1, when the cap base 1 is formed, injection molding the cap cover 2 on a basis of the cap base 1, so that the cap base 1 and the cap cover 2 are integrally formed; by setting injection molding materials of different colors to successively injection mold the cap base 1 and the cap cover 2, a multi-color keyboard keycap is realized and can be customized according to a requirement; actually, the cap cover 2 of the keycap is not limited to a transparent material and a translucent material, and is not limited to white, black, and red.

Please refer to FIG. 1 to FIG. 5, taking a spacebar keycap as an example for a display, remaining keycap structures similar to the spacebar keycap are similar with different dimensions; wherein, the cap cover 2 of the spacebar keycap is composed of a rectangular top plate 21 and a trapezoidal side plate 22. The cap base 1 is a transparent or translucent cap-shaped body, an outer side of the cap base 1 is provided with a contour ridge; so that a light at a key position transmits through the contour ridge of the cap base 1 to emit the light; meanwhile, the cap base 1 itself can be injection molded with transparent or translucent materials of different colors, providing richer color effects. Specifically, the contour ridge includes an upper ring ridge 11 and a plurality of edge ridges 12 integrally connected, a top plate groove 111 is opened at a top end of the cap base 1, a side plate groove 121 is opened on a side surface of the cap base 1, the protruding upper ring ridge 11 is formed between the top plate groove 111 and the plurality of side plate grooves 121, the protruding edge ridge 12 is formed between two adjacent the side plate grooves 121; the edge ridge 12 extends to a bottom end surface of the cap base 1, and a dimension of the upper ring ridge 11 and a dimension of the edge ridge 12 can be customized according to an actual requirement.

The cap cover 2 includes a top plate 21 and a plurality of side plates 22, the plurality of side plates 22 connect a side edge of the top plate 21 through a connecting block 23 to form a cap-shaped structure, a contour line hole is formed between the top plate 21 and the plurality of side plates 22; the contour ridge is matching installed in the contour line hole; FIG. 1 to FIG. 5 take a spacebar keycap as an example; while FIG. 6 to FIG. 8, are a specially shaped Enter key keycap, a top plate 21 of a cap cover 2 of the specially shaped Enter key keycap is an L-shaped plate, a side plate 22 of the specially shaped Enter key keycap besides a trapezoidal side plate, also exists an L-shaped plate. More specifically, the top plate 21 is matching installed in the top plate groove 111; the side plate 22 is matching installed in the side plate groove 121; when the top plate 21 and the plurality of side plates 22 of the cap cover 2 are installed in the corresponding top plate groove 111 and the side plate groove 121, an upper end surface of the upper ring ridge 11 connects smoothly with an upper surface of the top plate 21, a side surface of the upper ring ridge 11 and two outer side surfaces of the edge ridge 12 connect smoothly with an outer side surface of a corresponding the side plate 22, ensuring that an outer surface of the entire keycap is smooth without affecting a user experience. More specifically, please refer to FIG. 2, a plurality of connecting posts 13 are integrally connected to an inner bottom of the cap base 1, a cross-shaped connecting hole is opened at a bottom end of the connecting post 13, the cross-shaped connecting hole is matching installed with a cross-shaped fixture of a corresponding key position of a keyboard; facilitating an installation of the keycap on the corresponding key position of the keyboard.

As a desired solution, please refer to FIG. 3, FIG. 5, FIG. 7 and FIG. 8, a plurality of connecting holes 231 are opened along a bottom surface edge line of the top plate groove 111 of the cap base 1, the connecting hole 231 extends and penetrates through a bottom surface of the side plate groove 121, the connecting block 23 is matching installed in the connecting hole 231; by installing the connecting block 23 in the connecting hole 231, the connecting block 23 is integrally injection molded with the top plate 21 and the plurality of side plates 22 of the cap cover 2 and connected to the cap base 1, ensuring a stability of a connection between the cap base 1 and the cap cover 2.

As a desired solution, please refer to FIG. 3 and FIG. 5, a plurality of strip-shaped reinforcing holes 1111 are opened on a bottom surface of the top plate groove 111; a plurality of strip-shaped reinforcing ribs 211 are integrally connected to an inner bottom surface of the cap cover 2, the strip-shaped reinforcing rib 211 is correspondingly matching installed in the strip-shaped reinforcing hole 1111; by installing the strip-shaped reinforcing rib 211 in the strip-shaped reinforcing hole 1111, the strip-shaped reinforcing rib 211 is integrally injection molded with the top plate 21 and the plurality of side plates 22 of the cap cover 2 and connected to the cap base 1, ensuring a stability of a connection between the cap base 1 and the cap cover 2.

The present disclosure forms a complete keycap by injection molding the cap base 1 and the cap cover 2 to realize a multi-color keyboard keycap; the cap base 1 is a transparent or translucent cap-shaped body and the cap base 1 is provided with a contour ridge; a light transmits through the contour ridge of the cap base 1 to emit the light, and when matched with a color of the cap cover 2, both a light transmission effect and highlighting of an own color can be achieved; meanwhile, the cap base 1 itself can be injection molded with transparent or translucent materials of different colors, providing richer color effects, and meeting a market demand.

FIG. 9 to FIG. 158 are embodiments 2-26 provided by the application.

FIG. 1A to FIG. 18G are embodiments 27-44 provided by the application.

Although the present disclosure has been disclosed in the form of embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

What is claimed is:

1. A multi-color keyboard keycap with a protruding contour line comprising:
a cap base and a cap cover connected to each other, the cap base and the cap cover are both cap-shaped with a bottom opening, the cap cover is installed on an outer side of the cap base;
wherein:
the cap base is a transparent or translucent cap-shaped body, an outer side of the cap base is provided with a contour ridge;
the cap cover comprises a top plate and a plurality of side plates, the plurality of side plates connect a side edge of the top plate through a connecting block to form a cap-shaped structure, a contour line hole is formed between the top plate and the plurality of side plates; and
the contour ridge is matching installed in the contour line hole.

2. The multi-color keyboard keycap with the protruding contour line according to claim 1, wherein the contour ridge comprises an upper ring ridge and a plurality of edge ridges integrally connected, a top plate groove is opened at a top end of the cap base, a side plate groove is opened on a side surface of the cap base, the protruding upper ring ridge is formed between the top plate groove and a plurality of side plate grooves, the protruding edge ridge is formed between two adjacent side plate grooves.

3. The multi-color keyboard keycap with the protruding contour line according to claim 2, wherein:
the top plate is matching installed in the top plate groove; and
the side plate is matching installed in the side plate groove.

4. The multi-color keyboard keycap with the protruding contour line according to claim 3, wherein a plurality of connecting holes are opened along a bottom surface edge line of the top plate groove of the cap base, the connecting hole extends and penetrates through a bottom surface of the side plate groove, the connecting block is matching installed in the connecting hole.

5. The multi-color keyboard keycap with the protruding contour line according to claim 4, wherein:
a plurality of strip-shaped reinforcing holes are opened on a bottom surface of the top plate groove;
a plurality of strip-shaped reinforcing ribs are integrally connected to an inner bottom surface of the cap cover, the strip-shaped reinforcing rib is correspondingly matching installed in the strip-shaped reinforcing hole.

6. The multi-color keyboard keycap with the protruding contour line according to claim 5, wherein a plurality of connecting posts are integrally connected to an inner bottom of the cap base, a cross-shaped connecting hole is opened at a bottom end of the connecting post, the cross-shaped connecting hole is matching installed with a cross-shaped fixture of a corresponding key position of a keyboard.
